(19) United States
(12) Patent Application Publication
(10) Pub. No.: US 2009/0235308 A1
(43) Pub. Date: Sep. 17, 2009

(54) METHOD OF CONTENT SUBSTITUTION

(75) Inventors: Enno Lars Ehlers, Hamburg (DE); Mauro Barbieri, Eindhoven (NL); Johannes Weda, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/306,090

(22) PCT Filed: Jun. 26, 2007
(86) PCT No.: PCT/IB07/52467

§ 371 Date: Dec. 22, 2008

(30) Foreign Application Priority Data
Jul. 4, 2006 (EP) 06116559.3

(51) Int. Cl. H04N 7/10

(52) U.S. Cl. 725/34; 725/32

(57) ABSTRACT

A method of substituting a primary content (110) being transmitted on a primary channel (100) with a secondary content (220), characterized by said secondary content being a summary of a program (210) being currently transmitted on a secondary channel (200). Preferably the method comprises substitution of the secondary content (220) in response to a commercial break (120) being transmitted on the primary channel (100). Preferably the method comprises transmission of the primary content (110) following the substituted secondary content (220) that is time-shifted to allow the secondary content to be presented to its end. Preferably the method comprises subsequent to presenting the secondary content (220), the program being currently transmitted on the secondary channel (210) that is presented instead of the primary content (110). Preferably the method comprises transmission of the secondary content (220) that is prior to changing of the channel currently watched from the primary channel (100) to the secondary channel (200).

### TECHNICAL FIELD

The invention relates to a method of substituting a primary content being transmitted on the primary channel with a secondary content.

### TECHNICAL BACKGROUND

Nowadays TV broadcast offers a multiplicity of TV programs to be watched. Often it is difficult to choose a single program from all programs that are broadcast simultaneously and that are of interest to a user. In such a case, the user can decide to watch one program while recording another in order to watch it later.

The patent application US 2002/0194595 A1 discloses a method for collecting content and performing a substitution for a broadcast content. The method proposes aggregating substitute content based upon a user preference, delivering the aggregated substitute content, and displaying the aggregated substitute content in response to a break such as a commercial break or interruption of a broadcast content. The substitute content can be a previously-recorded programming content, a live programming content, or content from the Internet. Aggregation in this application is understood as locating and collecting programming content (or portions of a programming content) related to a specific topic as specified by the user.

This method merely allows a user to switch to the substitute content in case one of the above-mentioned break occurs. While the chosen substitute content is likely to be of interest, this switching can be confusing to the user when the substitute content is also broadcast content. Typically in such a case the viewer ends up somewhere in the middle of the substitute content. A solution to this problem would be to present the substitute content from the beginning, i.e. in a time-shifted fashion, but this is often not desirable for broadcast content, especially when the content is a live event such as a football match.

### SUMMARY OF THE INVENTION

It is an object of the invention to provide an enhanced method of substituting a primary content being transmitted on the primary channel with a secondary content, which at least partially alleviates the above situation.

This object is achieved according to invention in a method as stated above, characterized by the secondary content being a summary of a program being currently transmitted on a secondary channel. As the summary of the program comprises highlights of the program the user gathers in a short time the knowledge, which otherwise would need to be gathered through watching of the actual program. This provides him with more context, and allows him to catch up quickly with the secondary content. Having caught up, he can continue to watch the secondary content ‘live’ if he so desires, or switch back to the primary content.

In an embodiment, the secondary content is substituted in response to a commercial break being transmitted on the primary channel. This allows to position in time the substitution of the secondary content such that it is least invasive/annoying to the user. Instead of spending time on watching commercials, the user can be brought up-to-date with other programs that are transmitted simultaneously with the program the user is watching currently and are of more importance to the user.

Preferably in this embodiment a duration of the secondary content is adjusted to correspond to a duration of the commercial break. This has the advantage that the user can catch up with the secondary content in exactly the time that he can spend without missing anything from the primary content. Effectively now he can watch two programs at the same time.

In another embodiment, transmission of the primary content following the substituted secondary content is time-shifted to allow the secondary content to be transmitted to its end. This allows smooth transition between the different programs that are intertwined with each other. This embodiment prevents an abrupt termination of the summary in order to get back to watching the transmission of the primary content on the primary channel when the commercial break on the primary channel is finished.

In another embodiment, the program being transmitted on the secondary channel corresponds to a live event. This enables the user to be up-to-date with the live events. The user could possibly record the program and watch it afterwards. However, for programs covering live events this is not so appealing, as the live-aspect of the program is lost when watched at the later time. With this embodiment the user is provided with the program summary with a slight delay and does not loose the live-experience corresponding to the event.

In another embodiment, subsequent to presenting the secondary content, the program being currently transmitted on the secondary channel is presented instead of the primary content. In case the program on the secondary channel has just recently started, the secondary content being a summary can be quite short, leaving ample of time till changing to the primary channel again. In the meantime the user can watch the program being currently transmitted on the secondary channel. This allows the user to brought up-to-date with the program on the secondary channel and enjoy watching part of this program.

In another embodiment, transmission of the secondary content is prior to changing of the channel currently watched from the primary channel to the secondary channel. This allows the user to transit smoothly from one program to the other. Instead of changing to another channel and wonder what has happened in the program before, the user is provided with the summary that brings the user up-to-date with a part of the program transmitted in the past and the user can actively watch the program content that follows.

In another embodiment, the user explicitly provides the secondary channel. This allows the user to have control over the choice of the secondary channel. If the user has to choose between the two channels on which the programs that are of interest to the user are transmitted simultaneously, the user can choose one as the primary channel and the other one as the secondary channel.

In another embodiment, the secondary channel is derived based on user preferences. If the secondary channel is not explicitly assigned and user does not want to watch e.g. commercial breaks, the secondary channel can be chosen based on the user preferences provided beforehand. This allows the user to be confronted with the content which can be of interest to the user, as provided in the user preferences, instead of watching the commercial breaks that do not mean much to the user.

In another embodiment, the summary comprised in the secondary content is created for a content of the program being currently transmitted on the secondary channel and said content not being included in the previously transmitted summary corresponding to said program. This allows the user to be presented with only incremental updates with no duplication of the content. Or in other words it allows efficiently to spend time to give program summary updates without repeating the content already shown before.

The invention further provides a device for use in the method according to the invention.

### BRIEF DESCRIPTION OF THE DRAWINGS

These and other aspects of the invention will be apparent from and elucidated with reference to the embodiments shown in the drawings, in which:

FIG. 1 illustrates a method of substituting a primary content being transmitted on a primary channel with a secondary content, characterized by said secondary content being a summary of a program being currently transmitted on a secondary channel;

FIG. 2 shows schematically the secondary content being substituted in response to a commercial break being transmitted on the primary channel;

FIG. 3 illustrates transmission of the primary content following the substituted secondary content that is time-shifted to allow the secondary content to be presented to its end;

FIG. 4 shows schematically that subsequent to presenting the secondary content, the program being currently transmitted on the secondary channel is presented instead of the primary content;

FIG. 5 illustrates transmission of the secondary content that is prior to changing of the channel currently watched from the primary channel to the secondary channel;

FIG. 6 shows schematically a situation where multiple items of secondary content are presented;

FIG. 7 shows schematically an example architecture of the device implementing the claimed method.

Throughout the figures, same reference numerals indicate similar or corresponding features. Some of the features indicated in the drawings are typically implemented in software, and as such represent software entities, such as software modules or objects.

### DETAILED DESCRIPTION OF THE PREFERRED EMBODIMENTS

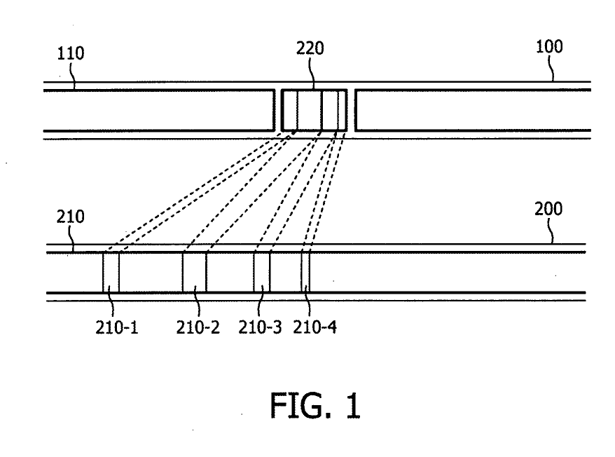

FIG. 1 illustrates a method of substituting a primary content 110 being transmitted on a primary channel 100 with a secondary content 220, characterized by said secondary content 220 being a summary of a program being currently transmitted on a secondary channel 200. In FIG. 1 the primary content 110 is transmitted on the primary channel 100. On the secondary channel 200 the program content 210 is transmitted. The secondary content 220 that is used to substitute the primary content 110 is the summary of the program that is currently transmitted on the secondary channel 200. The summary comprises a selection of certain segments, namely segments 210-1 till 210-4, of the program 210 being currently transmitted on the secondary channel 200. Each segment is a sequence of consecutive video frames.

Some examples of channels are e.g. BBC4 for the primary channel 100 and BBC1 for the secondary channel 200. The primary content 110 is e.g. the movie “Jurassic Park”, while the content 210 simultaneously transmitted on the secondary channel is e.g. an episode of the soap opera “Eastenders”.

Although the content discussed above refers to broadcast video, other types of content are possible. The content could also comprise audio. The programs that comprise the content are for example: music clips (songs), other forms of audio, home video, video-on-demand, movies, video clips, multimedia content, news, Internet streams, graphics, etc., or combination of such.

The content does not need per se to be provided by real-time TV broadcast. The content could be streamed from, for example, the server on the Internet or from the server of the home entertainment system.

Various methods that create a summary of an arbitrary video and/or audio content are well-known. Some of these are based on: content analysis, highlight detection, blank frame detection, structure analysis, etc. An overview of such methods may be found e.g. in Cuneyt M. Taskiran, Evaluation of automatic video summarization systems, Proc. SPIE Int. Soc. Opt. Eng. 6073, 60730K (2006).

Below we give a few examples of prior art methods of for creating a summary. Muvee autoProducer www.muvee.com provides automatic summary creation from the video content. US 2002/0157095 discloses using of meta data to calculate content scores for video segments of content. Consequently importance levels for these content segments are determined from content scores. U.S. Pat. No. 5,995,095 discloses hierarchical digital video summarization based on key-frames of the video sequence. Yet another example of summary creation is disclosed in Barbieri M., Weda H., Dimitrova N., “Browsing Video Recordings Using Movie-in-a-Minute”, Proc. of the IEEE International Conference on Consumer Electronics, ICCE 2006, pp. 301-302, Jan. 7-11, 2006, Las Vegas, USA.

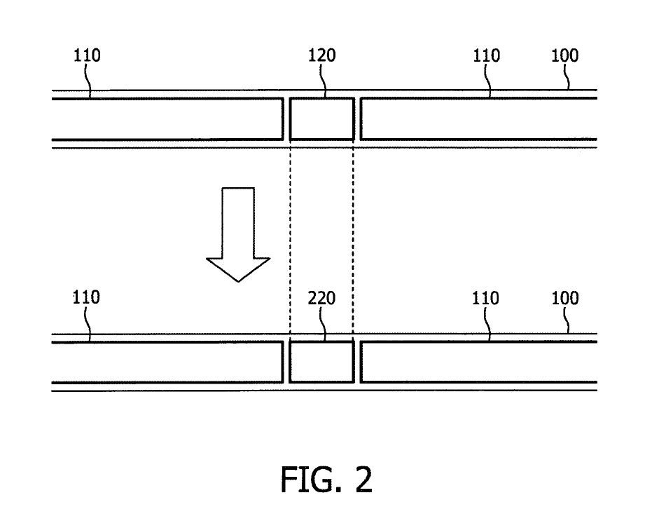

FIG. 2 shows schematically the secondary content 220 being substituted in response to a commercial break 120 being transmitted on the primary channel 100. The top part of FIG. 2 depicts the primary content 110 being transmitted on the primary channel 100 that is disrupted by the transmission of the commercial break 120. The bottom part of FIG. 2 shows the result of the substitution of the commercial break 120 with the secondary content 220.

There are many known methods that can be used for a detection of commercial breaks. For example, U.S. Pat. No. 5,987,210 discloses detecting of “black” frames in the video signal as the markers of the commercial breaks. A “black” frame is one in which there is essentially no video signal at all, and they precede and follow commercial messages in television broadcasts of the major U.S. networks. Alternatively, WO 01/89209 A2 discloses that TV broadcast includes an insertion order that states the network, date, scheduled program broadcast time, and the play position, which uniquely indicate the transmission times and duration of the commercial breaks.

In the example depicted in FIG. 2 a duration of the substituted secondary content 220 is adjusted to correspond to the duration of the commercial break 120. The duration of the commercial break 120 is then a constraint that is taken into account when creating the summary.

In the preferred embodiment the commercial break 120 comprised in the primary content 110 is indicated as the content to be substituted by the secondary content 220. However other alternatives are also possible for the content transmitted on the primary channel 100 to be substituted. For example, the user could indicate certain parts of the primary content 110 that comprise/present/show certain TV presenters, or fixed blocks in the programs such as e.g. weather forecast, which the user considers as not interesting and which should be substituted with the secondary content 220. The user through use of the dedicated button or specific graphical user interface explicitly indicates these less interesting or less desired parts of the TV programming. Alternatively, the user could provide his preferences beforehand and the content could be analyzed in order to automatically detect these undesirable parts of the primary content 110.

In the preferred embodiment the length of the secondary content 220 may be adjusted to correspond to a duration of the commercial break 120. Many summarization techniques allow for the creation of summaries of arbitrary length.

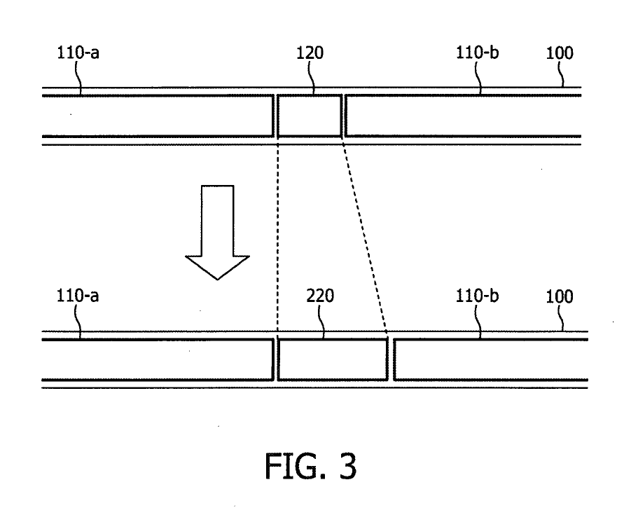

FIG. 3 illustrates transmission of the primary content 110 following the substituted secondary content 220 that is time-shifted to allow the secondary content 220 to be presented to its end.

The top part of the figure depicts the primary content 110 being transmitted on the primary channel 100 that is disrupted by the transmission of the commercial break 120. The primary content 110 comprises the content 110-a preceding the commercial break and the content 110-b following the commercial break. The bottom part of the figure shows the result of the substitution of the commercial break 120 with the secondary content 220. The duration of the secondary content 220 exceeds the duration of the commercial break 120. To provide to the user with the continuity of the program comprised in the primary content 110 the content 110-b is time-shifted.

Time-shifting of the transmission of the primary content 110 requires buffering of the primary content 110. The required buffering space is rather small as the time shift is expected also to be small. The time-shift corresponds to the time needed to the summary to be presented to its end and not being abruptly cut.

To support smooth transition between the content corresponding to the different programs, the changing of a content context is announced to the user through e.g. overlay logo or overlay text, or a ticker tape. The information comprised in one of these means provides the user with e.g. the program title, date and time of the program emission. Providing content context switch information holds for both: changing to the secondary content 220 as well as for returning to the primary content 110. Supplying of such context switch information reduces confusion with the viewer.

Alternatively, the secondary content could be displayed as a picture-in-picture. The user can then choose whether the secondary content should be displayed in the foreground or in a small picture.

According to one of the embodiments (not shown in figures) the program 210 being transmitted on the secondary channel 200 corresponds to a live event. The live program is for example the coverage of an athletic meeting, a football match, a session of parliament, breaking news, or live concert. The automatic summary creation methods provide the user with a rather objective summary. Alternatively, the selection of the content for the summary could be more subjective. This is achieved through personalization of the summary. The user can provide his/her preferences concerning the topics that are of special interest to the user. These could be e.g. favorite sport disciplines, favorite football player, favorite political topics, favorite economical topics, favorite entertainment topics, favorite artist, etc. The user could also provide dislike-preferences that are used to dismiss some of the content from the summary.

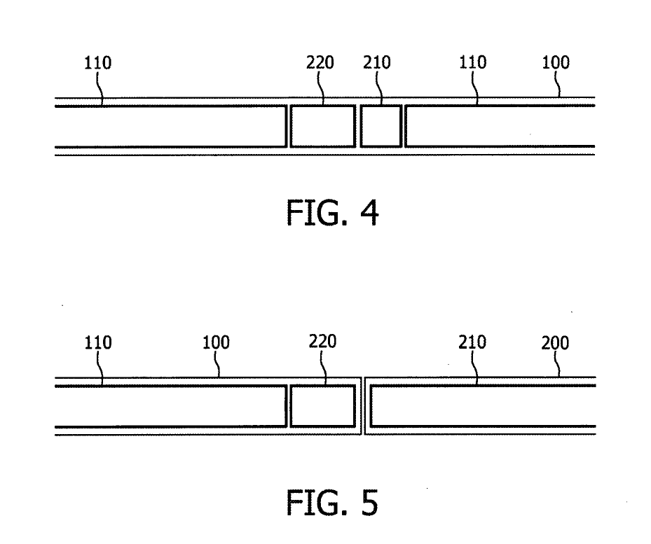

FIG. 4 shows schematically that subsequent to presenting the secondary content 220, the program being currently transmitted on the secondary channel 210 is presented instead of the primary content 110. In the figure the transmission of the primary content 110 on the primary channel 100 has a gap in which the secondary content 220 is substituted. However, the duration of the secondary content 220 does not fill the time gap entirely. This could be for the reason that the program for which the summary is made has began just recently. In such a case the program as is currently transmitted on the secondary channel 200 is presented to the user. This allows in a smooth and pleasant manner to bridge the gap in the primary content 110.

The moment to terminate the content used to bridge the gap in the primary content 110 should be chosen carefully to avoid abrupt context switches. This means that the slight time shifting could be used to provide user with the smooth content transitions.

Alternatively, instead of the actually transmitted program on the secondary channel 200 yet another summary of another program that could be of interest to the user and is currently transmitted could be provided to fill-in the gap in the primary content 110.

The summary could also be of the program that has been transmitted in the past on the secondary channel 200 and has been prerecorded by the user.

FIG. 5 illustrates transmission of the secondary content 220 that is prior to changing of the channel currently watched from the primary channel 100 to the secondary channel 200. This allows the user to transit smoothly from one program to the other. Instead of changing to another channel and wonder what has happened in the program before, the user is provided with the summary that brings the user up-to-date with a part of the program already transmitted in the past and the user can actively watch the program content that follows.

In the preferred embodiment the user explicitly provides the secondary channel 200. The user explicitly assigns the secondary channel 200 beforehand. So the user does not need to perform any interaction once confronted with e.g. the commercial break 120.

In another embodiment the secondary channel 200 is derived based on user preferences. The choice of the secondary channel 200 could be made automatically based on the users preferences. The user can beforehand provide the list of the topics (=preferences) that are interesting to the user. The Electronic Programming Guide (EPG) for example could be used to find the best match between the user preferences and the description of programs being transmitted on channels.

Alternatively, a content analysis of the transmitted programs or an analysis of meta data provided simultaneously with the transmitted programs could be used to make the selection of the secondary channel 200.

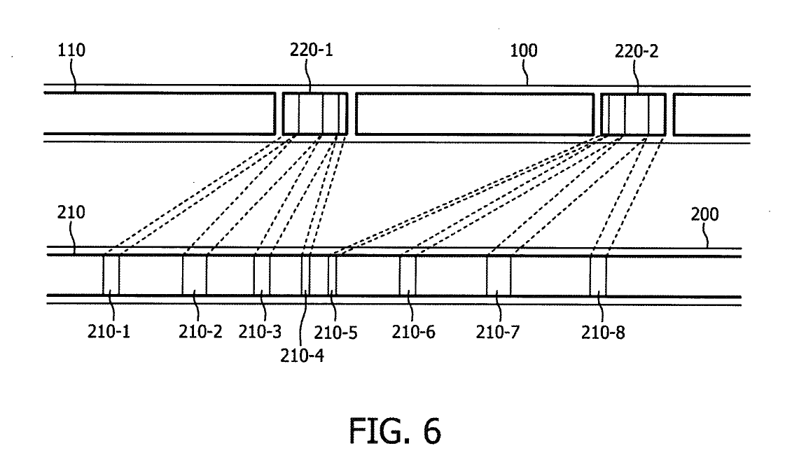

FIG. 6 shows schematically a situation where multiple items of secondary content 220-1 and 220-2 are presented. From FIG. 6 it is apparent that the summary comprised in a second secondary content 220-2 is incremental and does not overlap with the previously presented first secondary content 220-1. The summary comprised in the secondary content 220-2 (a set of segments 210-5 till 210-8) is created for a content of the program being currently transmitted on the secondary channel 200 and said content not being included in the previously transmitted secondary content 220-1 (a set of segments 210-1 till 210-4) corresponding to said program.

Similarly, when the secondary content 220 is followed by the content corresponding to the program currently transmitted on the secondary channel 200 in the gap in the primary content 110, the secondary content 220 that is created at the later stage should not comprise the content that has been already presented to the user previously as the content aligned to the previous secondary content 220.

Alternatively, the secondary content 220 could be prepared for the programs that have been transmitted and prerecorded by the user in the past and are in direct relation with the program transmitted currently on the secondary channel 200. A good example of such a situation is a soap opera. It is possible that the user is interested in an episode of the soap opera that is currently transmitted on the secondary channel 200. However, the user has already missed two previous episodes that he/she has prerecorded. In such a case it does not make sense to provide the user with the summary of the current episode as the user can have difficulties to follow the story line, as he/she has missed the two previous episodes. Therefore the user is presented first with the summaries of the two previous episodes followed by the summary of the current episode.

The above allows the user to be presented with only incremental updates with no duplication of the content. Or in other words it allows efficiently to spend time to give program summary updates without repeating the content already shown before.

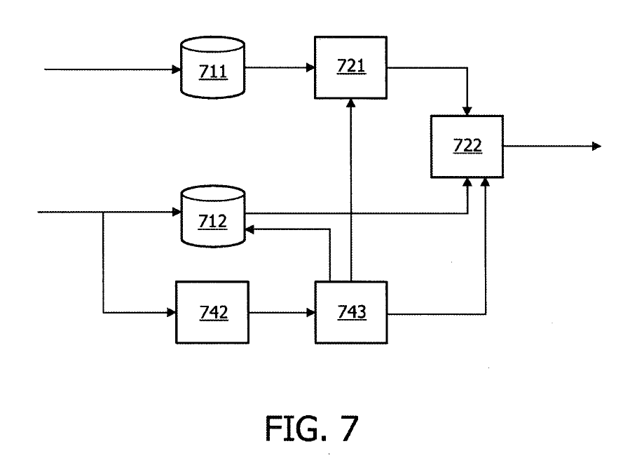

FIG. 7 shows schematically an example architecture of the device implementing the claimed method. The content transmitted on the primary channel 100 and on the secondary channel 200 are buffered in respective buffers 712 and 711, respectively. The primary content 110 is simultaneously fed into a commercial detector 742 to detect a commercial break. When the commercial break is detected a trigger event is communicated to a control means 743 that in turn initiates a substitution of the secondary content 220. The control means 743 instruct a means 721 for creating the secondary content being the summary to retrieve the relevant content from the buffering means 711 and to create the corresponding secondary content 220. Simultaneously, the control means 743 instructs a means 722 for substituting the primary content 110 with the secondary content 220 to retrieve the secondary content 220 from the means 721 and to forward the retrieved content further. When the secondary content 220 is finished the forwarding of the primary content 110 is resumed.

The control means 743 has also the control over forwarding of the content currently transmitted on the secondary channel and being aligned to the secondary content 220 already substituted in the gap in the primary content 110. The control means 743 are also controlling time-shifting of the transmission of the primary content 110 adjusted to the substituted content termination.

When there are multiple secondary channels that provide multiple secondary contents to be inserted in the gap in the primary content, the branch comprising the means 711 and 721 is duplicated for each additional secondary channel 200. The control means 743 has then control over the multiple secondary contents.

The described architecture can be implemented in many consumer devices such as for example set-top boxes, cable modems, or home entertainment systems. The output content of the means 722 is further provided to e.g. a TV set, which presents the content to the user.

It should be noted that the above-mentioned embodiments illustrate rather than limit the invention, and those skilled in the art will be able to design many alternative embodiments without departing from the scope of the appended claims. For instance instead of video content audio content could be used.

In the accompanying claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. A method of substituting a primary content (110) being transmitted on a primary channel (100) with a secondary content (220), characterized by said secondary content being a summary of a program (210) being currently transmitted on a secondary channel (200).

2. A method as claimed in claim 1, wherein the secondary content (220) is substituted in response to a commercial break (120) being transmitted on the primary channel (100).

3. A method as claimed in claim 2, wherein a duration of the secondary content (220) is adjusted to correspond to a duration of the commercial break (120).

4. A method as claimed in claim 1, wherein transmission of the primary content (110) following the substituted secondary content (220) is time-shifted to allow the secondary content to be presented to its end.

5. A method as claimed in claim 1, wherein the program (210) being transmitted on the secondary channel corresponds to a live event.

6. A method as claimed in claim 1, wherein subsequent to presenting the secondary content (220), the program being currently transmitted on the secondary channel (210) is presented instead of the primary content (110).

7. A method as claimed in claim 1, wherein transmission of the secondary content (220) is prior to changing of the channel currently watched from the primary channel (100) to the secondary channel (200).

8. A method as claimed in claim 1, wherein the user explicitly provides the secondary channel (200).

9. A method as claimed in claim 1, wherein the secondary channel (200) is derived based on user preferences.

10. A method as claimed in claim 1, wherein the summary comprised in the secondary content (220) is created for a content of the program (210) being currently transmitted on the secondary channel (200) and said content not being included in the previously transmitted summary corresponding to said program.

11. A device operable to provide a means (711 and 721) for creating a secondary content being a summary of a program being currently transmitted on a secondary channel, and a means (722) for substituting the primary content being transmitted on a primary channel with the secondary content, said device being operable according to a method claimed in claim 1.

12. A device as claimed in claim 11, further comprising a commercial detector (742) to detect a commercial break being transmitted on the primary channel, and a control means (743) for initiating a substitution of said secondary content in response to the commercial break being transmitted on the primary channel.

13. A device as claimed in claim 11, further comprising a buffer (712) to store the primary content in order to enable time-shifted transmission of said primary content to allow the substituted secondary content to be transmitted to its end.

14. A device as claimed in claim 11, said device being operable to transmit the secondary content prior to changing of the channel currently watched from the primary channel to the secondary channel.

15. Software executable on device hardware for implementing a method as claimed in claim 1.
